(19) United States
(12) Patent Application Publication
(10) Pub. No.: US 2019/0044152 A1
(43) Pub. Date: Feb. 7, 2019

(54) NONAQUEOUS ELECTROLYTE SECONDARY CELL

(71) Applicant: SANYO Electric Co., Ltd., Daito-shi, Osaka (JP)

(72) Inventors: Takafumi Sakida, Hyogo (JP); Sanae Hashitani, Osaka (JP); Akira Nagasaki, Osaka (JP)

(73) Assignee: SANYO Electric Co., Ltd., Daito-shi, Osaka (JP)

(21) Appl. No.: 16/074,557

(22) PCT Filed: Feb. 14, 2017
(86) PCT No.: PCT/JP2017/005217

§ 371 Date: Aug. 1, 2018

(30) Foreign Application Priority Data
Feb. 26, 2016 (JP) 2016-034954

(51) Int. Cl. H01M 4/62; H01M 2/02; H01M 2/34; H01M 4/131; H01M 4/525; H01M 10/0525; H01M 10/0567

(52) U.S. Cl. CPC H01M 4/628; H01M 2/022; H01M 2/345; H01M 2004/028; H01M 4/525; H01M 10/0525; H01M 10/0567; H01M 4/131

(57) ABSTRACT

A nonaqueous electrolyte secondary cell according to an aspect of the invention includes a positive electrode plate containing a positive electrode active material, a negative electrode plate containing a negative electrode active material, a separator disposed between the positive electrode plate and the negative electrode plate, a nonaqueous electrolyte, an outer can in a cylindrical shape having a bottom, and a sealing member including a current breaker configured to be activated when pressure in the cell reaches a predetermined value. The positive electrode active material is a lithium nickel composite oxide expressed by a general formula of LiₓNi_{y}M_{(1-y)}O₂ (O<x≤1.2, 0.85≤y≤0.99, M is at least one element selected from Al, Co, Fe, Cu, Mg, Ti, Zr, Ce, and W). The positive electrode plate contains lithium carbonate in an amount of 0.01% to 0.2% by mass with respect to the positive electrode active material.

### TECHNICAL FIELD

The present invention relates to a nonaqueous electrolyte secondary cell including a sealing member having a current breaker.

### BACKGROUND ART

A nonaqueous electrolyte secondary cell, which has a high energy density, has been widely used as a drive source of portable electronic devices, such as smartphones, tablet computers, laptop computers, and portable music players. In recent years, the application of nonaqueous electrolyte secondary cells has been expanded to electronic tools, electronic bicycles, and electronic cars, requiring nonaqueous electrolyte secondary cells to have a high level of safety.

Since the nonaqueous electrolyte secondary cell has a sealed structure, gas is generated in the cell if the nonaqueous electrolyte secondary cell is overcharged due to improper use or malfunction of a charger. The gas increases pressure in the cell. If the nonaqueous electrolyte secondary cell is kept overcharging for a long time, the cell may explode or ignite. To prevent an explosion or ignition, the nonaqueous electrolyte secondary cell has a current breaker for cutting the current path in the cell when the pressure in the cell increases to a predetermined value. The current breaker has a valve that is deformed by a rise in internal pressure of the cell. The deformed valve breaks a portion of the current path in the cell.

A gas that does not induce a chemical reaction responsible for thermal runaway needs to be rapidly generated in the cell to promptly activate the current breaker. In the techniques disclosed in Patent Literature 1 and Patent Literature 2, a positive electrode plate contains lithium carbonate to generate carbon dioxide when the cell is overcharged.

In the techniques disclosed in Patent Literature 3 to Patent Literature 7, nonaqueous electrolytes contain benzene derivatives having different substituents to improve safety of the overcharged nonaqueous electrolyte secondary cell. The benzene derivatives, which undergo a polymerization reaction or oxidative decomposition at the positive electrode when the cell is overcharged, are expected to accelerate the generation of gas.

### CITATION LIST

### Patent Literature

PTL 1: Japanese Published Unexamined Patent Application No. H04-328278
PTL 2: Japanese Published Unexamined Patent Application No. 2008-186792
PTL 3: Japanese Published Unexamined Patent Application No. H05-036439
PTL 4: Japanese Published Unexamined Patent Application No. H09-171840
PTL 5: Japanese Published Unexamined Patent Application No. 2001-015155
PTL 6: Japanese Published Unexamined Patent Application No. 2002-260725
PTL 7: Japanese Published Unexamined Patent Application No. 2014-102877

### SUMMARY OF INVENTION

### Technical Problem

Excessive addition of lithium carbonate to the positive electrode plate of the nonaqueous electrolyte secondary cell may degrade cell characteristics in a high-temperature environment, such as high-temperature cycle characteristics and high-temperature stability. Thus, it is preferable that the amount of lithium carbonate added to the positive electrode plate be small. Prompt activation of the current breaker with such a small amount of lithium carbonate requires a technique for efficiently decomposing the lithium carbonate when the cell is overcharged.

The present invention was made in view of the above-described circumstances, and an object thereof is to provide a nonaqueous electrolyte secondary cell having a current breaker that is promptly activated by using a small amount of lithium carbonate when the cell is overcharged.

### Solution to Problem

A nonaqueous electrolyte secondary cell according to a first aspect of the invention includes a positive electrode plate containing a positive electrode active material, a negative electrode plate containing a negative electrode active material, a separator disposed between the positive electrode plate and the negative electrode plate, a nonaqueous electrolyte, an outer can in a cylindrical shape having a bottom, and a sealing member including a current breaker configured to be activated when pressure in the cell reaches a predetermined value. The positive electrode active material is a lithium nickel composite oxide expressed by a general formula of LiₓNi_{y}M_{(1-y)}O₂ (O<x≤1.2, 0.85≤y≤0.99, M is at least one element selected from Al, Co, Fe, Cu, Mg, Ti, Zr, Ce, and W), and the positive electrode plate contains lithium carbonate in an amount of not less than 0.01% by mass and not more than 0.2% by mass with respect to mass of the positive electrode active material.

A nonaqueous electrolyte secondary cell according to a second aspect of the invention includes a positive electrode plate containing a positive electrode active material, a negative electrode plate containing a negative electrode active material, a separator disposed between the positive electrode plate and the negative electrode plate, a nonaqueous electrolyte, an outer can in a cylindrical shape having a bottom, and a sealing member including a current breaker configured to be activated when pressure in the cell reaches a predetermined value. The positive electrode active material is a lithium nickel composite oxide expressed by a general formula of LiₓNi_{y}M_{(1-y)}O₂ (O<x≤1.2, 0.88≤y≤0.99, M is at least one element selected from Al, Co, Fe, Cu, Mg, Ti, Zr, Ce, and W), and the positive electrode plate contains lithium carbonate in an amount of not less than 0.01% by mass and not more than 0.2% by mass with respect to mass of the positive electrode active material.

### Advantageous Effects of Invention

According to an aspect of the present invention, the current breaker is promptly activated by using a small amount of lithium carbonate when the cell is overcharged. The aspect of the invention provides a nonaqueous electrolyte secondary cell that is provided with both cell characteristics in a high-temperature environment and safety when the cell is overcharged.

### BRIEF DESCRIPTION OF DRAWINGS

FIG. 1 is a sectional perspective view of a nonaqueous electrolyte secondary cell according to Experimental examples.

### DESCRIPTION OF EMBODIMENTS

A lithium nickel composite oxide represented by a general formula of LiₓNi_{y}M_{(1-y)}O₂ is used as a positive electrode active material. For example, the positive electrode active material is produced by firing lithium hydroxide, which is a source of lithium, with nickel and a composite oxide including other metal element M in an oxygen atmosphere. In the lithium nickel composite oxide immediately after being produced, x is preferably not less than 1 and not greater than 1.2. Since lithium is released from the lithium nickel composite oxide while the cell is charged, x in the lithium nickel composite oxide included as the positive electrode active material in the nonaqueous electrolyte secondary cell is specified as 0<x≤1.2.

The electrical resistance of lithium nickel composite oxide increases at a high state of charge (SOC) with an increase in the nickel content. In other words, polarization of the positive electrode in the overcharged cell increases with an increase in the nickel content, and the positive electrode quickly reaches the decomposition potential of lithium carbonate. The value of y in the general formula is preferably not less than 0.85 and more preferably not less than 0.88. A portion of Ni is preferably substituted with at least one element selected from Al, Co, Fe, Cu, Mg, Ti, Zr, Ce, and W to improve the cell characteristics and safety of the lithium nickel composite oxide. The value of y is preferably not more than 0.99.

The positive electrode plate may be produced by applying a positive electrode mixture slurry including a positive electrode active material to a positive electrode current collector, followed by drying, for example. The positive electrode mixture slurry may be produced by placing a positive electrode active material and a binder in a dispersion medium, followed by kneading. A conductive agent may be added to the positive electrode mixture slurry.

The negative electrode active material may be a carbon material that can store and release lithium ions or a metal material that can be alloyed with lithium. Examples of the carbon material include graphite, such as natural graphite or artificial graphite. Examples of the metal material include silicon, tin, or oxides thereof. The carbon material and the metal material may be used alone or in a combination of two or more kinds thereof.

The negative electrode plate may be produced by applying a negative electrode mixture slurry including a negative electrode active material to a negative electrode current collector, followed by drying, for example. The negative electrode mixture slurry may be produced by placing a negative electrode active material and a binder in a dispersion medium, followed by kneading. A thickener may be added to the negative electrode mixture slurry.

A microporous membrane composed mainly of a polyolefin, such as polyethylene (PE) or polypropylene (PP), may be used as a separator. One microporous membrane or two or more microporous membranes laminated on one another may be used. A laminate separator composed of two or more layers preferably includes an intermediate layer composed mainly of polyethylene (PE), which has a low melting point, and a surface layer composed of polypropylene (PP), which has high oxidation resistance. Furthermore, inorganic particles such as aluminum oxide (Al₂O₃), titanium oxide (TiO₂), and silicon oxide (SiO₂) may be added to the separator. Such inorganic particles may be supported in the separator or may be applied with the binder to the surface of the separator.

The positive electrode plate and the negative electrode plate are wound with the separator therebetween to form an electrode assembly. The electrode assembly is disposed in an outer can in a cylindrical shape having a bottom with a nonaqueous electrolyte. The cell is sealed by swaging to the opening of the outer can in a cylindrical shape having a bottom with a gasket being interposed therebetween. The sealing member has a current breaker configured to cut the current path when the pressure in the cell reaches a predetermined value.

The nonaqueous electrolyte may be prepared by dissolving a lithium salt as an electrolyte salt in a nonaqueous solvent, for example.

The nonaqueous solvent may be a cyclic carbonate ester, a chain carbonate ester, a cyclic carboxylate ester, or a chain carboxylate ester and is preferably a mixture of at least two of them. Examples of the cyclic carbonate ester include ethylene carbonate (EC), propylene carbonate (PC), and butylene carbonate (BC). A cyclic carbonate ester in which hydrogen is partly substituted with fluorine, such as fluoroethylene carbonate (FEC), may also be used. Examples of the chain carbonate ester include dimethyl carbonate (DMC), ethyl methyl carbonate (EMC), diethyl carbonate (DEC), and methyl propyl carbonate (MPC). Examples of the cyclic carboxylate ester include γ-butyrolactone (γ-BL) and γ-valerolactone (γ-VL). Examples of the chain carboxylate ester include methyl pivalate, ethyl pivalate, methyl isobutyrate, and methyl propionate.

Examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, and Li₂B₁₂Cl₁₂. Among these, LiPF₆ is particularly preferred, and the concentration thereof in the nonaqueous electrolyte preferably ranges from 0.5 to 2.0 mol/L. LiPF₆ may be mixed with another lithium salt, such as LiBF₄.

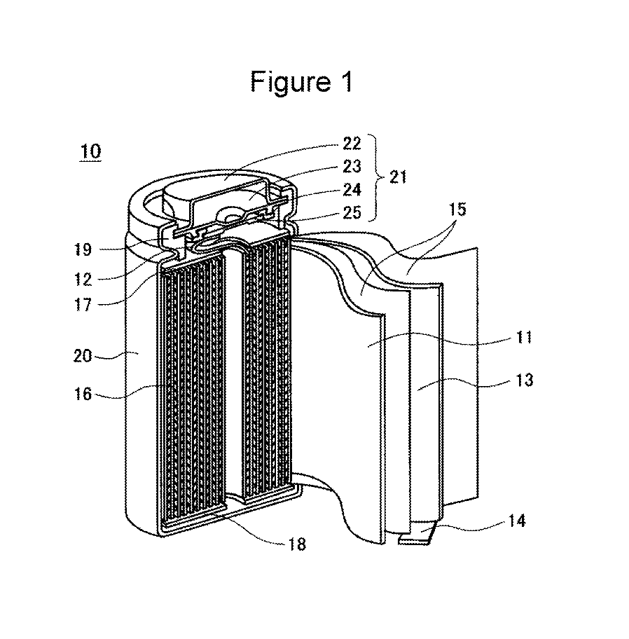

Hereinafter, an embodiment of the invention is described in detail with reference to Experimental examples of a nonaqueous electrolyte secondary cell illustrated in FIG. 1. The invention is not limited to Experimental examples described below and may be suitably modified without departing from the gist of the invention.

### Experimental Example 1

(Production of Positive Electrode Plate)

Lithium hydroxide and a composite oxide represented by Ni_{0.85}Co_{0.12}Al_{0.03}O₂ were mixed together such that a ratio of the number of moles of the lithium hydroxide to the total number of moles of metal elements in the composite oxide was 1.025. The mixture was baked for 18 hours at 750° C. in an oxygen atmosphere to produce a lithium nickel composite oxide represented by LiNi_{0.5}Co_{0.12}Al_{0.03}O₂.

One hundred parts by mass of the lithium nickel composite oxide produced as above, 1 part by mass of acetylene black as a conductive agent, 0.9 parts by mass of polyvinylidene fluoride as a binder, and 0.05 parts by mass of lithium carbonate (Li₂CO₃) were mixed together. The mixture was placed in N-methyl-2-pyrrolidone as a dispersion medium and kneaded to produce a positive electrode mixture slurry. The positive electrode mixture slurry was applied to two surfaces of a positive electrode current collector made of an aluminum foil and dried to form a positive electrode mixture layer. The positive electrode mixture layer was compressed to a predetermined thickness. Then, the compressed electrode plate was cut to a predetermined dimension. Lastly, a positive electrode tab 12 was connected to an exposed portion of the positive electrode current collector where the positive electrode mixture layer was not formed. Thus, the positive electrode plate 11 was produced.

(Production of Negative Electrode Plate)

Ninety-seven parts by mass of graphite as a negative electrode active material, 1.5 parts by mass of styrene-butadiene rubber as a binder, and 1.5 parts by mass of carboxymethyl cellulose as a thickener were mixed together. The mixture was placed in water as a dispersion medium and kneaded to produce a negative electrode mixture slurry. The negative electrode mixture slurry was applied to two surfaces of a negative electrode current collector made of a copper foil and dried to form a negative electrode mixture layer. The negative electrode mixture layer was compressed to a predetermined thickness. Then, the compressed electrode plate was cut into a predetermined dimension. Lastly, a negative electrode tab 14 was connected to an exposed portion of the negative electrode current collector where the negative electrode mixture layer was not formed. Thus, a negative electrode plate 13 was produced.

(Production of Electrode Assembly)

The positive electrode plate 11 and the negative electrode plate 13 were wound with a separator 15 formed of a polyethylene microporous membrane therebetween to produce an electrode assembly 16. The end of the separator, which is the winding end of the electrode assembly 16, was fixed with an adhesive tape.

(Preparation of Nonaqueous Electrolyte)

Ethylene carbonate (EC) and dimethyl carbonate (DMC) were mixed at a volume ratio of 3:7 (1 atm, 25° C.) to prepare a nonaqueous solvent. Lithium hexafluorophosphate (LiPF₆) as an electrolyte salt was dissolved in the nonaqueous solvent at a concentration of 1.0 mol/L to prepare a nonaqueous electrolyte.

(Production of Sealing Member)

A terminal cap 22, a valve 23, an annular insulating plate 24, and a terminal plate 25 were stacked on one another to produce a sealing member 21. The valve 23 and the terminal plate 25 are aluminum plates. The valve 23 is deformable in response to an increase in pressure in the cell. The terminal plate 25 has a plurality of ventilation holes to enable the cell pressure to be applied to the valve 23. The valve 23 and the terminal plate 25 are disconnected when the cell pressure reaches a predetermined value. This cuts the current path in the sealing member. In this way, in Experimental example 1, the current breaker is composed of the valve 23, the insulating plate 24, and the terminal plate 25.

(Production of Nonaqueous Electrolyte Secondary Cell)

An upper insulating plate 17 and a lower insulating plate 18 were respectively disposed on the top and the bottom of the electrode assembly 16. The electrode assembly 16 was disposed in the outer can 20. The negative electrode tab 14 was connected to the bottom of the outer can 20. The positive electrode tab 12 was connected to the sealing member 21. A nonaqueous electrolyte was placed in the outer can 20. Then, the sealing member 21 was swaged to the opening of the outer can 20 with the gasket 19 therebetween. Thus, a nonaqueous electrolyte secondary cell 10 according to Experimental example 1 was produced.

### Experimental Examples 2 to 5

Nonaqueous electrolyte secondary cells 10 according to Experimental examples 2 to 5 were produced in substantially the same manner as in Experimental example 1 except that the amount of lithium carbonate was changed to the values in Table 1. The amount of lithium carbonate in Table 1 is expressed as percentage of the mass of the positive electrode active material.

### Experimental Example 6

A nonaqueous electrolyte secondary cell 10 according to Experimental example 6 was produced in substantially the same manner as in Experimental example 1 except that the nonaqueous electrolyte contained cyclohexylbenzene. The content of cyclohexylbenzene was 1% by mass with respect to the mass of a nonaqueous solvent.

### Experimental Example 7

A nonaqueous electrolyte secondary cell 10 according to Experimental example 7 was produced in substantially the same manner as in Experimental example 1 except that the nonaqueous electrolyte contained tert-butylbenzene. The content of tert-butylbenzene was 1% by mass with respect to the mass of a nonaqueous solvent.

### Experimental Examples 8 to 12

Nonaqueous electrolyte secondary cells 10 according to Experimental examples 8 to 12 were produced in substantially the same manner as in Experimental example 1 except that a lithium nickel composite oxide represented by LiNi_{0.88}Co_{0.09}Al_{0.03}O₂ was used as the positive electrode active material and the amount of lithium carbonate was changed to the values in Table 1.

### Experimental Examples 13 to 17

Nonaqueous electrolyte secondary cells 10 according to Experimental examples 13 to 17 were produced in substantially the same manner as in Experimental example 1 except that a lithium nickel composite oxide represented by LiNi_{0.91}Co_{0.6}Al_{0.03}O₂ was used as the positive electrode active material and the amount of lithium carbonate was changed to the values in Table 1.

### Experimental Examples 18 to 22

Nonaqueous electrolyte secondary cells 10 according to Experimental examples 18 to 22 were produced in substantially the same manner as in Experimental example 1 except that a lithium nickel composite oxide represented by LiNi_{0.82}Co_{0.15}Al_{0.03}O₂ was used as the positive electrode active material and the amount of lithium carbonate was changed to the values in Table 1.

### Experimental Example 23

A nonaqueous electrolyte secondary cell 10 according to Experimental example 23 was produced in substantially the same manner as in Experimental examples 8 to 12 except that the amount of lithium carbonate was changed to 0.3% by mass with respect to the mass of the positive electrode material.

(Overcharging Test)

The cells in Experimental examples 1 to 22 were each charged with a constant current of 0.3 It. The state of charge (SOC) and the maximum end temperature at the activation of the current breaker were determined. The results are shown in Table 1.

TABLE 1

| | | | Additive to | SOC at | Maximum | |
|---|---|---|---|---|---|---|
| | Positive Electrode | Amount | Nonaqueous | Current | End | |
| | Active Material | of Li₂CO₃ | Electrolyte | Cutoff | Temperature | |
| Experimental Example 1 | LiNi_{0.85}Co_{0.12}Al_{0.03}O₂ | 0.05% | None | 121% | 92° | C. |
| Experimental Example 2 | | 0.1% | | 121% | 85° | C. |
| Experimental Example 3 | | 0.15% | | 120% | 79° | C. |
| Experimental Example 4 | | 0.2% | | 120% | 76° | C. |
| Experimental Example 5 | | 0% | | 124% | 138° | C. |
| Experimental Example 6 | | 0.05% | Cyclohexyl | 118% | 60° | C. |
| | | | Benzene | | | |
| Experimental Example 7 | | 0.05% | Tert-Butyl | 119% | 60° | C. |
| | | | Benzene | | | |
| Experimental Example 8 | LiNi_{0.88}Co_{0.09}Al_{0.03}O₂ | 0.05% | None | 118% | 60° | C. |
| Experimental Example 9 | | 0.1% | | 118% | 58° | C. |
| Experimental Example 10 | | 0.15% | | 117% | 56° | C. |
| Experimental Example 11 | | 0.2% | | 117% | 55° | C. |
| Experimental Example 12 | | 0% | | 123% | 122° | C. |
| Experimental Example 13 | LiNi_{0.91}Co_{0.06}Al_{0.03}O₂ | 0.05% | None | 116% | 55° | C. |
| Experimental Example 14 | | 0.1% | | 116% | 55° | C. |
| Experimental Example 15 | | 0.15% | | 115% | 54° | C. |
| Experimental Example 16 | | 0.2% | | 115% | 54° | C. |
| Experimental Example 17 | | 0% | | 122% | 105° | C. |
| Experimental Example 18 | LiNi_{0.82}Co_{0.15}Al_{0.03}O₂ | 0.05% | None | 123% | 126° | C. |
| Experimental Example 19 | | 0.1% | | 122% | 107° | C. |
| Experimental Example 20 | | 0.15% | | 121% | 95° | C. |
| Experimental Example 21 | | 0.2% | | 120% | 82° | C. |
| Experimental Example 22 | | 0% | | 125% | 148° | C. |

In Experimental examples 18 to 22 each using a lithium nickel composite oxide expressed by the general formula of LiₓNi_{y}M_{(1-y)}O₂ in which y is 0.82, the larger the amount of lithium carbonate, the lower the maximum end temperature of the overcharged cell, because the current breaker is activated earlier. However, in Experimental examples 18 and 19 each employing a small amount of lithium carbonate, the maximum end temperature of the cell is higher than 100° C. A larger amount of lithium carbonate is needed to improve safety when the cell is overcharged.

In contrast, in Experimental examples 1 to 5 in which y in the general formula of LiₓNi_{y}M_{(1-y)}O₂ is 0.85, the maximum end temperature of each cell is less than 100° C. due to the lithium carbonate added to the positive electrode plate, indicating a high level of safety. Furthermore, in Experimental examples 8 to 17, as in Experimental examples 1 to 5, the larger the value of y, the lower the maximum end temperature of the cell. In other words, a larger amount of nickel in the lithium nickel composite oxide enables the lithium carbonate in the positive electrode plate to be efficiently decomposed, accelerating generation of carbon dioxide. The above results indicate that a small amount of lithium carbonate improves safety of the overcharged nonaqueous electrolyte secondary cell when y is not less than 0.85. Safety of the overcharged cell is further improved when y is not less than 0.88. Thus, y is more preferably not less than 0.88.

Even a small amount of lithium carbonate in the positive electrode plate improves safety of the nonaqueous electrolyte secondary cell overcharged. A preferable amount of lithium carbonate is not less than 0.01% by mass with respect to the mass of the positive electrode active material, more preferably not less than 0.05% by mass.

The maximum end temperature of the cell in Experimental example 6, in which a nonaqueous electrolyte contains cyclohexylbenzene as a benzene derivative, is much lower than that in Experimental example 1, in which a nonaqueous electrolyte does not contain cyclohexylbenzene. Furthermore, the maximum end temperature in Experimental example 7, in which a nonaqueous electrolyte contains tert-butylbenzene as a benzene derivative, is 60° C., which is equal to the maximum end temperature in Experimental example 6. These results indicate that it is preferable that the nonaqueous electrolyte contain a benzene derivative. Since polarization at the time of overcharging is high in the lithium nickel composite oxide according to the invention, not only the lithium carbonate but also the benzene derivative is efficiently decomposed on the positive electrode. This synergistically improves safety when the cell is overcharged.

(High-Temperature Cycle Test)

The cells in Experimental examples 8 to 12 and 23 were each charged at a constant current of 0.3 It until the voltage of each cell reached 4.2 V. Then, the cells were each charged with a low voltage of 4.2 V until the current reached 0.02 It. Then, the cells were each discharged at a constant current of 0.5 It until the cell voltage reached 2.5 V. The charge/discharge cycle was repeated 1000 times in a 45° C. environment. The ratio of the discharge capacity at the 1000th cycle to the discharge capacity at the first cycle was calculated as a capacity retention ratio. The results are shown in Table 2.

TABLE 2

| | | Amount | Capacity |
|---|---|---|---|
| | Positive Electrode | of | Retention |
| | Active Material | Li₂CO₃ | ratio |
| Experimental Example 8 | LiNi_{0.88}Co_{0.09}Al_{0.03}O₂ | 0.05% | 73% |
| Experimental Example 9 | | 0.1% | 72% |
| Experimental Example 10 | | 0.15% | 72% |
| Experimental Example 11 | | 0.2% | 71% |
| Experimental Example 12 | | 0% | 73% |
| Experimental Example 23 | | 0.3% | 67% |

Comparison between Experimental example 12 and Experimental example 23 reveals that the cycle characteristics are largely degraded by the addition of 0.3% by mass of lithium carbonate to the positive electrode plate. However, the capacity retention ratio in each of Experimental examples 8 to 11 exceeds 70%. The effect of lithium carbonate on the cycle characteristics is reduced when the amount of lithium carbonate added to the positive electrode plate is not more than 0.2% by mass. In view of high-temperature cycle characteristics, the amount of lithium carbonate added to the positive electrode plate is preferably not more than 0.2% by mass. In light of the results of the overcharge test indicated in Table 1, the amount of lithium carbonate added to the positive electrode plate is preferably not less than 0.01% by mass and not more than 0.2% by mass, more preferably not less than 0.05% by mass and not more than 0.2% by mass to achieve both safety when the cell is overcharged and high-temperature cycle characteristics.

In Experimental examples, cobalt (Co) and aluminum (Al) were used as different elements. However, other elements, such as iron (Fe), copper (Cu), magnesium (Mg), titanium (Ti), zirconium (Zr), cerium (Ce), and tungsten (W) may be used. These different elements may be used alone or in combination.

In Experimental examples, cyclohexylbenzene and tert-butylbenzene were used as benzene derivatives. However, other benzene derivatives, such as tert-pentylbenzene, biphenyl, fluorobenzene, trifluorobenzene, benzene, hexafluorobenzene, phenyl lactone, diphenylether, diphenylcarbonate, and methylphenylcarbonate may be used. These benzene derivatives may be used alone or in combination. The benzene derivative content in the nonaqueous electrolyte is preferably not less than 0.1% by mass and not more than 5% by mass with respect to the mass of the nonaqueous solvent.

### INDUSTRIAL APPLICABILITY

According to the present invention, as described above, the current breaker is promptly activated by using a small amount of lithium carbonate when the cell is overcharged. Since the present invention provides a nonaqueous electrolyte secondary cell having both cell characteristics in a high-temperature environment and safety when the cell is overcharged, the present invention has high industrial applicability.

### REFERENCE SIGNS LIST

10 nonaqueous electrolyte secondary cell
11 positive electrode plate
13 negative electrode plate
15 separator
20 outer can
21 sealing member

1. A nonaqueous electrolyte secondary cell comprising a positive electrode plate containing a positive electrode active material, a negative electrode plate containing a negative electrode active material, a separator disposed between the positive electrode plate and the negative electrode plate, a nonaqueous electrolyte, an outer can in a cylindrical shape having a bottom, and a sealing member including a current breaker configured to be activated when pressure in the cell reaches a predetermined value, wherein
the positive electrode active material is a lithium nickel composite oxide expressed by a general formula of LiₓNi_{y}M_{(1-y)}O₂ (O<x≤1.2, 0.85≤y≤0.99, M is at least one element selected from Al, Co, Fe, Cu, Mg, Ti, Zr, Ce, and W), and
the positive electrode plate contains lithium carbonate in an amount of not less than 0.01% by mass and not more than 0.2% by mass with respect to mass of the positive electrode active material.

2. A nonaqueous electrolyte secondary cell comprising a positive electrode plate containing a positive electrode active material, a negative electrode plate containing a negative electrode active material, a separator disposed between the positive electrode plate and the negative electrode plate, a nonaqueous electrolyte, an outer can in a cylindrical shape having a bottom, and a sealing member including a current breaker configured to be activated when pressure in the cell reaches a predetermined value, wherein
the positive electrode active material is a lithium nickel composite oxide expressed by a general formula of LiₓNi_{y}M_{(1-y)}O₂ (O<x≤1.2, 0.88≤y≤0.99, M is at least one element selected from Al, Co, Fe, Cu, Mg, Ti, Zr, Ce, and W), and
the positive electrode plate contains lithium carbonate in an amount of not less than 0.01% by mass and not more than 0.2% by mass with respect to mass of the positive electrode active material.

3. The nonaqueous electrolyte secondary cell according to claim 1, wherein the nonaqueous electrolyte includes at least one benzene derivative selected from cyclohexylbenzene, tert-butylbenzene, tert-pentylbenzene, biphenyl, fluorobenzene, trifluorobenzene, benzene, hexafluorobenzene, phenyl lactone, diphenylether, diphenylcarbonate, and methylphenylcarbonate.

4. The nonaqueous electrolyte secondary cell according to claim 2, wherein the nonaqueous electrolyte includes at least one benzene derivative selected from cyclohexylbenzene, tert-butylbenzene, tert-pentylbenzene, biphenyl, fluorobenzene, trifluorobenzene, benzene, hexafluorobenzene, phenyl lactone, diphenylether, diphenylcarbonate, and methylphenylcarbonate.
